(19) United States
(12) Patent Application Publication
(10) Pub. No.: US 2026/0127741 A1
(43) Pub. Date: May 7, 2026

(54) System and Method for Generating Synthetic SWI obtained from T1 Weighted MRI Scans for Characterizing Brain Disease

(71) Applicant: Hong Kong Centre for Cerebro-Cardiovascular Health Engineering Limited, Pak Shek Kok (HK)

(72) Inventors: Kannie CHAN, Pak Shek Kok (HK); Abdul-Mojeed Olabisi ILYAS, Pak Shek Kok (HK); Jianpan HUANG, Pak Shek Kok (HK); Jamal Firmat BANZI, Pak Shek Kok (HK)

(21) Appl. No.: 19/169,305

(22) Filed: Apr. 3, 2025

Related U.S. Application Data
(60) Provisional application No. 63/716,813, filed on Nov. 6, 2024.

(51) Int. Cl. G06T 7/00

(52) U.S. Cl. CPC G06T 7/0014; G06T 2207/10088; G06T 2207/20081; G06T 2207/30016

(57) ABSTRACT

A system generating a simulated SWI image of a human brain based upon a single non-contrast (SNC) magnetic resonance (MR) image thereof comprising: an input image module storing an SNC MR image; a pre-processing module generating the SNC MR image into a standard format for an AI model to extract and classify features thereof; a simulated SWI-generating model compartment receiving the SNC MR image and generating a simulated SWI image corresponding thereto; a deep learning platform operating the AI model; a training module receiving and communicating training data to the deep learning platform whereby the AI model may be adjusted to optimize for generating the simulated SWI image; a testing module communicating with the training module and the deep learning platform to receive testing data and adapted to validate the simulated SWI image with pre-trained performance criteria; and an output storage compartment receiving and storing the synthetic SWI image.

### TECHNICAL FIELD

This invention relates to a method and system of generating Synthetic SWI obtained from T1 Weighted MRI scans for characterizing brain diseases, and in particular Parkinson's Related Disease.

### BACKGROUND

Magnetic resonance imaging (MRI) is a non-invasive technique used to visualize internal body structures, leveraging the relaxation properties of water protons in a magnetic field. MRI permits safe repeated scans with no known harm when used within well-defined technical constraints. MRI Images can be created with contrast reflecting proton density, T1 and T2 relaxation times, tissue susceptibility variations, diffusion, temperature, fields of motion, biomechanical properties, tissue perfusion, electrical currents, oxygen levels, and spectra of key biochemical species, etc. Among these sequences, T1-weighted imaging (T1-w) is widely employed in clinical settings to identify morphological changes in the brain but it is unable to reveal specific pathologies that need a more nuanced imaging technique.

Susceptibility weighted imaging (SWI) uses magnitude and filtered-phase information, both separately and in combination with each other, to create new sources of endogenic contrast enhancement. SWI shows high sensitivity for deoxygenated blood, hemosiderin, ferritin, and calcium. This makes SWI valuable for diagnosing neurological disorders like ageing, multiple sclerosis, stroke, cerebral hyperperfusion, traumatic brain injury, cerebral vascular malformations, intracranial artery stenosis and moyamoya disease, cerebral microbleeds, primary central nervous system vasculitis, mycotic aneurysm, brain tumour, and neurodegenerative disorders, such Alzheimer and Parkinson diseases. SWI plays a crucial role in detecting Parkinson's disease through the visualization of the swallow tail sign (STS). This sign is attributed to the presence of Nigrosome-1, the largest cluster of dopaminergic neurons, located in the dorsolateral substantia nigra.

However, the acquisition of SWI has been reported as time-consuming, with susceptibility artifacts potentially causing significant signal loss and reducing diagnostic accuracy. While technological advancements have helped streamline the SWI acquisition process, these artifacts remain a challenge, leading to substantial signal cancellation and a loss of anatomical detail. Additionally, SWI can be complex, often extending diagnostic procedures and introducing artifacts that may further compromise accuracy. Consequently, its availability may be limited compared to routine T1-weighted (T1w) MRI scans.

Recent advancements in machine learning, particularly the emergence of convolutional neural networks (CNNs), have shown significant potential in various medical image analysis tasks, including lesion detection, brain tumour segmentation, medical image super resolution, intra- and inter-modality medical image synthesis, and automatic vessel extraction methods.

For example, a Convolutional Neural Network (CNN)-based automated diagnostic system was employed to classify Parkinson's disease (PD) and healthy controls (HC). The Parkinson's Progression Markers Initiative (PPMI) was used as benchmark T2-weighted Magnetic Resonance Imaging (MRI) data for both PD and HC. Mid-brain slices from 500 T2-weighted MRI scans were selected and aligned using an image registration technique. The performance of the proposed method was evaluated based on accuracy, sensitivity, specificity, and the Area Under the Curve (AUC).

However, diagnosing the disease in its early stages can be challenging. The largest cluster of dopaminergic neurons, located in the dorsolateral substantia nigra (SN), specifically Nigrosome-1, is particularly affected in PD. On 3D susceptibility-weighted imaging (SWI) sequences, this region appears as a hyperintense structure against the otherwise hypointense SN, creating the characteristic “swallow tail sign” (STS).

Hence, Researchers have explored other image-to-image translation approaches to generate synthesized PD, T2, T2-FLAIR and MRA scans from different single-image or multi-input modalities. Some studies have utilized computationally expensive generative adversarial networks (GANs) in 2D and 3D modes while others have employed different variants of the U-Net, a deep-learning architecture.

Some approaches utilize multi-input modalities. However, there is a limited availability of validation data from diseased patients and extended time is required to acquire the necessary input images. In contrast, single-input modalities, such as T1-weighted (T1w) imaging, remain the preferred option due to their consistent availability in public MRI datasets. Given the clinical significance of SWI and the time-sensitive nature of diagnosing neurodegenerative diseases, it is essential to minimize both practical and clinical delays to establish an efficient SWI acquisition pathway. Optimizing the diagnostic process enables healthcare professionals to ensure timely and accurate differentiation of neurodegenerative conditions to diagnose brain diseases.

### SUMMARY OF THE INVENTION

According to a first aspect of the invention, there is provided a method for Synthetic SWI obtained from T1 weighted MRI scans for characterizing brain diseases, such as Parkinson's Related Disease.

According to a second aspect of the invention, there is provided a method for generating simulated SWI images using acquired single contrast MR image (T1-w MR image) by a system having at least a processor and a memory therein to execute instructions of an artificial intelligence engine configured to a UNet model stored within the memory of the system; wherein the UNet model comprises:
an encoder having a plurality of layer blocks, each of the layer blocks of the encoder comprising one or more convolutional layers, each of the convolution layers associating with an activation layer, and a down sampling layer;
a decoder having a plurality of layer blocks, each of the layer blocks of the decoder comprising one up-sampling layer, one or more convolutional layers, and each of the convolution layers associating with an activation layer;
a skip connection for associating with one of the layer blocks of the encoder with one of the layer blocks of the decoder at a corresponding multiscale resolution level;
wherein the encoder is adapted to extract features from the T1-w MR image for the decoder to combine outputs from the encoder and extracted image features in multiscale resolution levels through the skip connection to generate the simulated SWI images.

In a preferred embodiment, the encoder and the decoder are adapted to perform cross-sequence from a T1-w image to SWI image translation consisting of 19 convolutional layers.

In a preferred embodiment, the encoder is adapted to receive images comprising three dimensions and one or more color channels, wherein one or more layer blocks of the encoder comprises a repeated implementation of two 3×3 convolution layers with 2 voxels stride over five-layer blocks, and wherein a layer block of the encoder that immediately precedes the decoder comprises a single convolution layer.

In a preferred embodiment, the activation layer is adapted to conduct a linear rectification function by one or more rectified linear units (ReLU).

In a preferred embodiment, the down sampling comprises a 2×2×2 max-pooling operation with a stride of 2 voxels, wherein each of the convolutional layers is adapted to process input data with a number of convolutional filters.

In a preferred embodiment, the max-pooling operation after an activation layer reduces a spatial size of an image feature map by a factor of 2, and the number of convolutional filters doubles, from 16 in a first block to 1024 in a last block, such that the UNet model is permitted to learn a hierarchical relationships over a sizeable receptive field of the SNC MR image.

In a preferred embodiment, the up-sampling layer of the decoder is adapted to perform nearest-neighbor interpolation to increase image size through each layer block by a factor of 2 through each layer within the decoder.

In a preferred embodiment, one or more convolution layers with the decoder uses random initialization and unequalled kernel size.

In a preferred embodiment, the skip connection is adapted to copied and concatenated features generated from one of the layer blocks of the encoder to one of the layer blocks of the decoder at a corresponding multiscale resolution level, such that both high- and low-level features from the encoder to be utilized as additional inputs in the decoder to provide effective and stable image representation.

In a preferred embodiment, the output layer comprises a single output convolutional layer followed by an output activation layer, wherein the single output convolutional layer is a 1×1 convolutional layer with a stride of 1, and the output activation layer is adapted to conduct hyperbolic tangent (tanh) operations.

In a preferred embodiment, the system further comprises a diagnostic model adapted to classifying an abnormality in the simulated SWI images for characterization of a brain diseases. The abnormality is the absent of a swallow tail sign in a substantia nigra of the simulated SWI images that is characterized as the present of Parkinson's diseases.

According to a third aspect of the invention, there is provided a system for generating a simulated SWI image of a human brain based upon a single non-contrast (SNC) magnetic resonance (MR) image of the human brain, wherein the system comprising:
an input image module to store the SNC MR images;
a pre-processing module for receiving the SNC MR image, wherein the pre-processing module is adapted to prepare and generate the SNC MR image into a standard format for an artificial intelligence (AI) model to extract and classify features of SNC MR image;
a simulated SWI-generating model compartment for receiving the SNC MR images in the stand format and to generate simulated SWI image corresponding to each SNC image;
a deep learning platform for operating the AI model, wherein the AI model is a connected;
a training module for receiving and communicating training data to the deep learning platform whereby tunable parameters of the AI model may be adjusted to optimize for generating the simulated SWI image;
a testing module for communicating with the training module and the deep learning platform to receive testing data, wherein the testing module is adapted to validate the simulated SWI image with pre-trained performance criteria;
an output storage compartment for receiving and storing the synthetic SWI image.

According to a fourth aspect of the invention, there is provided a method for generating simulated SWI of a human brain based upon SNC MR images of the human brain without injection of a contrast agent into the body, the method comprising the steps of:
collecting SNC images;
inputting the SNC images into a training module; compartment;
collecting a corresponding SWI image for each subject in the SNC images;
storing the SWI images in the training compartment;
input the SNC images and the corresponding SWI images into an AI model;
training the AI model to generate a simulated SWI image based upon the SNC images input into the AI model and the corresponding SWI images as target outputs;
testing the simulated SWI images against the corresponding SWI images previously input into the AI model and optimizing the AI model input.

In a preferred embodiment, the SNC MR image is a T1-weighted image.

In a preferred embodiment, the SNC MR image is acquired from a MRI scanner of any model, including GE, Siemens, and Philips.

In a preferred embodiment, the SNC MR image can be acquired from MRI scanner of any field strength including 1.5 T, 3T, and 7T.

In a preferred embodiment, the training step for the AI model to generate the simulated SWI images comprises the step of applying deep learning techniques.

In a preferred embodiment, the steps of testing the simulated SWI images against the corresponding SWI images previously input into the AI model and optimizing the AI model input comprises the step of applying the deep learning techniques.

In a preferred embodiment, the method further comprises the steps of:
acquiring a SNC MR image of a person on an MRI scanner,
registering the SNC MR images to a standard non-contrast image template;
transferring registered SNC MR images to a storage compartment;
inputting the SNC MR images into a trained AI model;
generating simulated SWI images corresponding to the SNC MR input images and viewing images using a pe-existing software.

In a preferred embodiment, the step of training the AI model utilize an Adam stochastic optimization algorithm with a learning rate of 0.002 applied to minimize a mean-squared error (MSE) loss function in a stepwise fashion and update at every training step progressively until the AI model reaches convergence.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Embodiments of the present invention will now be described, by way of example, with reference to the accompanying drawings in which:

FIG. 1 is a schematic diagram of a computer system to implement for Synthetic SWI obtained from T1 weighted MRI scans for characterizing brain diseases according to an embodiment of the present invention.

FIG. 2 is a block diagram illustrating the workflow steps and components of the method used for developing the present invention including the model training and validation according to an embodiment of the present invention.

FIG. 3 is a block diagram showing various components of the system used to create the SWI simulation system according to an embodiment of the present invention.

FIG. 4 is a block diagram showing routine steps for using the present invention to generate simulated SWI images from T1-w images according to an embodiment of the present invention.

FIG. 5 is a schematic diagram of an encoder-decoder UNET architecture used for image translation in an embodiment of the present invention.

FIG. 6 is an image showing five axial slices of a T1w image (top row) and an SWI image (bottom row) acquired from an MRI scanner at different depths.

FIG. 7 is an image showing qualitative evaluation of the UNet method with SIMON dataset with a visual inspection of the axial slices at different depths in the (a) T1w input, (b) the synthetic SWI image, (c) the ground truth SWI and (d) the error map (synthetic-ground-truth).

FIG. 8 is an image showing qualitative evaluation of the UNet method with a visual inspection of the 2D axial slices of SWI at different depths in (a) a healthy subject, (b) and Parkinson's disease dementia patient, (c) a Parkinson's disease patient from a private clinical dataset and (d) healthy subject from the SIMON dataset, where the top row at each group is our prediction and the bottom right is the corresponding ground truth of each scan.

FIG. 9 is an image showing qualitative evaluation of the UNet method with a visual inspection of the substantia nigra in a (a) healthy subject, (b) and Parkinson's disease dementia patient, (c) Parkinson's disease patient from a private clinical dataset and (d) healthy subject from the SIMON dataset, corresponding to the subjects in FIG. 8.

FIG. 10 is an image qualitative evaluation of the model with a visual inspection of the T1w scan (left panel) and the synthetic SWI scan (right panel) for three ischemic stroke subjects.

FIG. 11 is a boxplot for the (a) structural similarity index measure (SSIM) and (b) peak signal-to-noise ratio (PSNR) for the retrospective private clinical dataset (pink), SIMON dataset (green) and the test set (blue).

FIG. 12 is a boxplot for the (a) structural similarity index measure (SSIM) and (b) peak signal-to-noise ratio (PSNR) for the healthy (H), Parkinson's disease (PD) and Parkinson's disease dementia (PDD) subjects within the retrospective dataset.

FIG. 13 is a boxplot for the (a) structural similarity index measure (SSIM) and (b) peak signal-to-noise ratio (PSNR) for results generated from a T1w scan from a Philips (pink) or SIEMENS (blue) scanner.

FIG. 14 is an image showing classification of the predicted SWI scan from the T1w acquired from the retrospective private clinical dataset.

### DETAILED DESCRIPTION OF THE PREFERRED EMBODIMENT

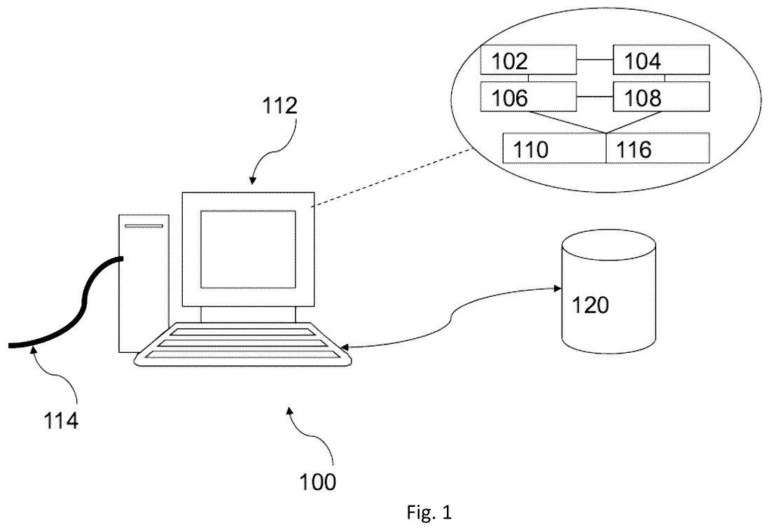

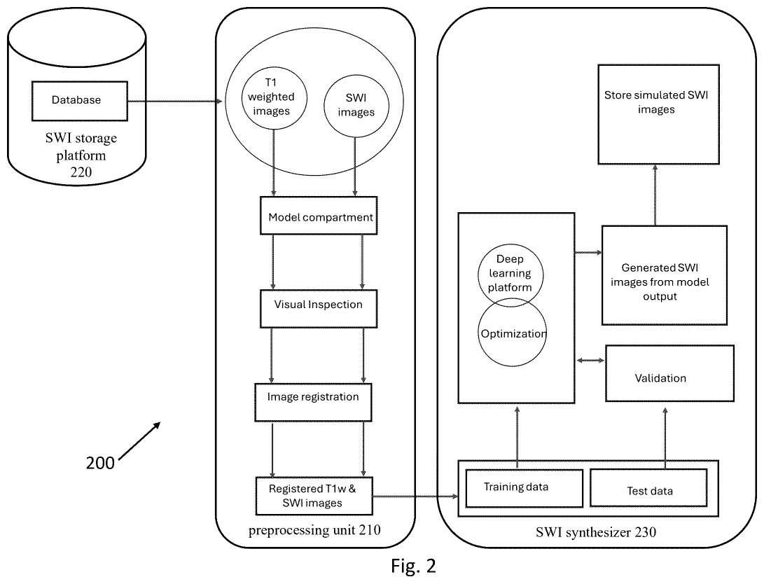

With reference to FIGS. 1 and 2, an embodiment of the present invention is illustrated. This embodiment is arranged to provide a system and method for the generation of synthetic SWI obtained from T1 weighted MRI scans for characterizing Parkinson's related disease.

In this example embodiment, the interface and processor are implemented by a computer having an appropriate user interface. The computer may be implemented by any computing architecture, including portable computers, tablet computers, stand-alone Personal Computers (PCs), smart devices, Internet of Things (IoT) devices, edge computing devices, client/server architecture, “dumb” terminal/mainframe architecture, cloud-computing based architecture, or any other appropriate architecture. The computing device may be appropriately programmed to implement the invention.

Turning to FIG. 1, there is provided a schematic diagram of a computer system or server 100 to implement a system for generating synthetic SWI obtained from T1 weighted MRI scans for characterizing Parkinson's related disease in accordance with an embodiment of the present invention.

This embodiment comprises a server 100 which includes suitable components necessary to receive, store and execute appropriate computer instructions. The components may include a processing unit 102, including Central Processing Units (CPUs), Math Co-Processing Unit (Math Processor), Graphic Processing United (GPUs) or Tensor processing units (TPUs) for tensor or multi-dimensional array calculations or manipulation operations, read-only memory (ROM) 104, random access memory (RAM) 106, and input/output devices such as disk drives 108, input devices 110 such as an Ethernet port, a USB port, etc. Display 112 such as a liquid crystal display, a light emitting display or any other suitable display and communications links 114 may also be present. The server 100 may include instructions that may be included in ROM 104, RAM 106 or disk drives 108 and may be executed by the processing unit 102. There may be provided a plurality of communication links 114 which may variously connect to one or more computing devices such as a server, personal computers, terminals, wireless or handheld computing devices, Internet of Things (IoT) devices, smart devices, edge computing devices. At least one of a plurality of communications link may be connected to an external computing network through a telephone line or other type of communications link.

The server 100 may also include storage devices such as a disk drive 108 which may encompass solid state drives, hard disk drives, optical drives, magnetic tape drives or remote or cloud-based storage devices. The server 100 may use a single disk drive or multiple disk drives, or a remote storage service. The server 100 may also have a suitable operating system 116 which resides on the disk drive or in the ROM of the server 100.

In one embodiment, system 200 comprises three main components: (1) a preprocessing unit 210 that normalizes and registers T1-w images into a standard template; (2) an SWI storage platform for securely storing the synthesized SWI images 220; and (3) an SWI synthesizer (SWI-s) 230 developed using the deep learning model. The SWI-s automatically generates SWI images from T1-w inputs within seconds, without any special patient preparation, enhancing efficiency and accessibility in clinical practice.

The methodology of the present invention uses a technique that combines image processing technology, (NIFTI (Neuroimaging informatics technology initiative) or DICOM formatting, deep learning and artificial intelligence, as observed below, to process selected inputs from which it generates SWI images for the disease diagnosis.

In one embodiment of the present invention, there is provided a system 200 for generating a simulated SWI image of a human brain based upon a single non-contrast (SNC) magnetic resonance (MR) image of the human brain. The system 200 comprising: an input image module to store the SNC MR images; a pre-processing module for receiving the SNC MR image, wherein the pre-processing module is adapted to prepare and generate the SNC MR image into a standard format for an artificial intelligence (AI) model to extract and classify features of SNC MR image; a simulated SWI-generating model compartment for receiving the SNC MR images in the stand format and to generate simulated SWI image corresponding to each SNC image; a deep learning platform for operating the AI model, wherein the AI model is a connected; a training module for receiving and communicating training data to the deep learning platform whereby tunable parameters of the AI model may be adjusted to optimize for generating the simulated SWI image; a testing module for communicating with the training module and the deep learning platform to receive testing data, wherein the testing module is adapted to validate the simulated SWI image with pre-trained performance criteria; and an output storage compartment for receiving and storing the synthetic SWI image.

In another embodiment of the present invention, there is provided a method 300 for generating simulated SWI of a human brain based upon SNC MR images of the human brain without injection of a contrast agent into the body, the method comprising the steps of: collecting SNC images; inputting the SNC images into a training module; compartment; collecting a corresponding SWI image for each subject in the SNC images; storing the SWI images in the training compartment; input the SNC images and the corresponding SWI images into an AI model; training the AI model to generate a simulated SWI image based upon the SNC images input into the AI model and the corresponding SWI images as target outputs; and testing the simulated SWI images against the corresponding SWI images previously input into the AI model and optimizing the AI model input.

The SNC MR image can be a T1-weighted image acquired from a MRI scanner of any model, including GE, Siemens, and Philips. The field strength can be 1.5 T, 3T, and 7T.

The training step for the AI model to generate the simulated SWI images comprises the step of applying deep learning techniques, and the steps of testing the simulated SWI images against the corresponding SWI images previously input into the AI model and optimizing the AI model input comprises the step of applying the deep learning techniques.

The method further comprises the steps of: acquiring a SNC MR image of a person on an MRI scanner, registering the SNC MR images to a standard non-contrast image template; transferring registered SNC MR images to a storage compartment; inputting the SNC MR images into a trained AI model; and generating simulated SWI images corresponding to the SNC MR input images and viewing images using a pe-existing software.

In one embodiment the step of training the AI model utilize an Adam stochastic optimization algorithm with a learning rate of 0.002 applied to minimize a mean-squared error (MSE) loss function in a stepwise fashion and update at every training step progressively until the AI model reaches convergence.

In yet another embodiment of the present invention, there is provided a method for generating simulated SWI images using acquired single contrast MR image (T1-w MR image) by a system having at least a processor and a memory therein to execute instructions of an artificial intelligence engine configured to a UNet model stored within the memory of the system; wherein the UNet model comprises:
an encoder having a plurality of layer blocks, each of the layer blocks of the encoder comprising one or more convolutional layers, each of the convolution layers associating with an activation layer, and a down sampling layer;
a decoder having a plurality of layer blocks, each of the layer blocks of the decoder comprising one up-sampling layer, one or more convolutional layers, and each of the convolution layers associating with an activation layer;
a skip connection for associating with one of the layer blocks of the encoder with one of the layer blocks of the decoder at a corresponding multiscale resolution level;
wherein the encoder is adapted to extract features from the T1-w MR image for the decoder to combine outputs from the encoder and extracted image features in multiscale resolution levels through the skip connection to generate the simulated SWI images.

The encoder and the decoder are adapted to perform cross-sequence from a T1-w image to SWI image translation consisting of 19 convolutional layers. The encoder is adapted to receive images comprising three dimensions and one or more color channels, wherein one or more layer blocks of the encoder comprises a repeated implementation of two 3×3 convolution layers with 2 voxels stride over five-layer blocks, and wherein a layer block of the encoder that immediately precedes the decoder comprises a single convolution layer. The activation layer is adapted to conduct a linear rectification function by one or more rectified linear units (ReLU). The down sampling comprises a 2×2×2 max-pooling operation with a stride of 2 voxels, wherein each of the convolutional layers is adapted to process input data with a number of convolutional filters. The max-pooling operation after an activation layer reduces a spatial size of an image feature map by a factor of 2, and the number of convolutional filters doubles, from 16 in a first block to 1024 in a last block, such that the UNet model is permitted to learn a hierarchical relationships over a sizeable receptive field of the SNC MR image.

The up-sampling layer of the decoder is adapted to perform nearest-neighbor interpolation to increase image size through each layer block by a factor of 2 through each layer within the decoder. One or more convolution layers with the decoder uses random initialization and unequalled kernel size. The skip connection is adapted to copied and concatenated features generated from one of the layer blocks of the encoder to one of the layer blocks of the decoder at a corresponding multiscale resolution level, such that both high- and low-level features from the encoder to be utilized as additional inputs in the decoder to provide effective and stable image representation. The output layer comprises a single output convolutional layer followed by an output activation layer, wherein the single output convolutional layer is a 1×1 convolutional layer with a stride of 1, and the output activation layer is adapted to conduct hyperbolic tangent (tanh) operations.

The system 200 further comprises a diagnostic model adapted to classifying a swallow tail sign in a substantia nigra of the simulated SWI images, wherein the swallow tail signal appears to demonstrate dorsolateral nigral hyperintensity.

The invention employs a deep learning-based algorithm that translates features from T1-w images to synthesize SWI. This method uses a training dataset of retrospectively collected T1-w images and their corresponding SWI images, allowing the algorithm to learn and generate high-quality SWI images from T1-w inputs.

In one embodiment of the present invention, the system 200 is adapted to synthesize 3D SWI images from 3D T1w scans using the Encoder Transformer Decoder Network (ETD-Net) framework, which has been trained and tested with the OASIS dataset. The system 200 is adapted to leverage advanced synthetic SWI for improved characterization of neurological disorders.

The experimental results showed that the AI model of the present invention achieved promising performance on the validation set, with a peak signal-to-noise ratio (PSNR) of 27.3±0.468 and structural similarity index (SSIM) of 0.809±0.0077.

The framework of an embodiment of the present invention is able to demonstrate high generalizability in evaluations with retrospective clinical and SIMON datasets, proved scanner-insensitive with SIMON datasets. Using the synthesized susceptibility-weighted imaging (SWI), the swallow tail sign was effectively utilized to differentiate between patients with vascular hallucinations (VH), Parkinson's disease (PD), and healthy individuals based on retrospective clinical data. Consequently, the synthesized SWI enabled the detection of microbleeds in patients with ischemic stroke.

The present invention opens possibilities for routine use of 3D SWI scans in clinical settings, for early neurodegenerative disease (ND) detection, treatment evaluation, and management, enhancing diagnostic and improving patient outcomes with timely interventions.

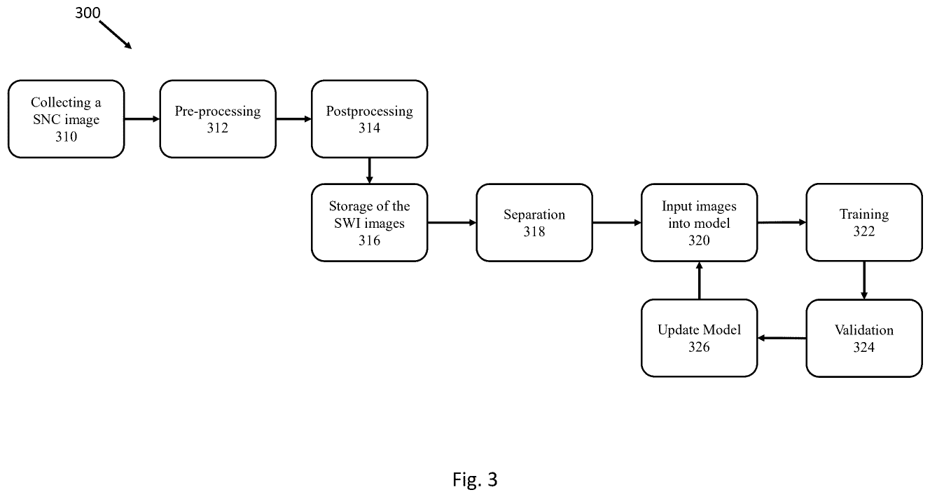

Referring to the block diagram in FIG. 3, the various components of the system 200 used to create the SWI simulation system, and the steps 300 involved, which include model training and testing, are:
1. Collecting a single non-contrast (SNC) image and corresponding SWI images from the database in Step 310;
2. Pre-processing the collecting images through visual inspection, voxel normalization, and template registration in the pre-processing module in Step 312;
3. Postprocessing the SWI images in Step 314;
4. Storage of the SWI images and corresponding SNC images in the input module in Step 316;
5. Separation of the image pairs into a series of training and test data in Step 318;
6. Input the SNC images and corresponding SWI images into the model in Step 320;
7. In the training module, the model is trained to learn the generation of simulated SWI images upon the use of the SNC image as the model input and the simulated SWI image as the target output. The tunable parameters of the model are adjusted so that the output images generated by the model are optimized to be analogous to the training data targets in Step 322;
8. Testing the simulated SWI images against the corresponding SWI images previously input into the model, which is standard to validate the model in the validation module in Step 324;
9. Updating the model with new data as it becomes available in Step 326.

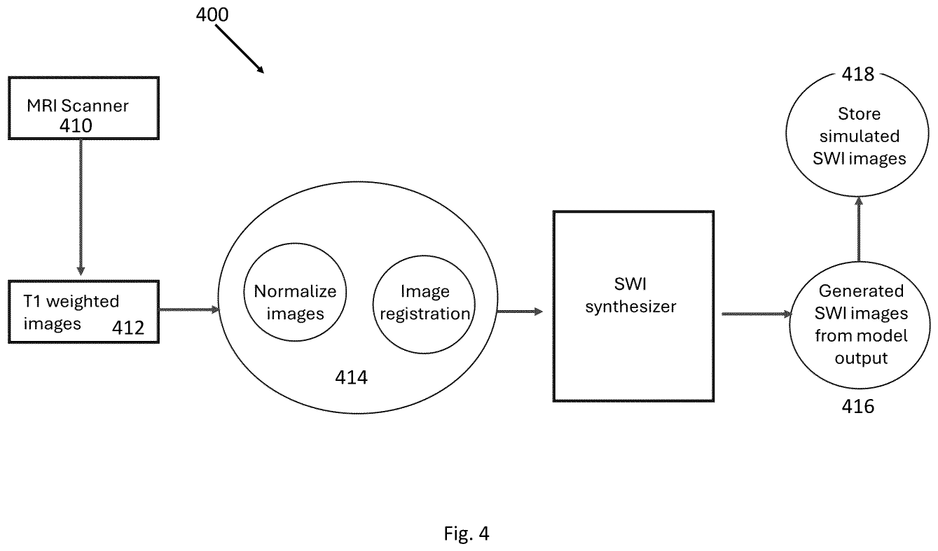

Reference is now made to FIG. 4 which describes the necessary process steps 400 for using the present invention indicated as described below.
1. The SNC images collected in NIFTI format from the MRI scanner are transferred into the input module in Step 412;
2. Pre-processing the SNC images through template registration and voxel normalization in Step 414;
3. Transfer the SNC images into the trained model compartment, which accepts SNC images as input and provides SWI images as output in Step 416;
4. Transfer the generated to a medical archiving or store it in an output storage module in Step 418.

In one preferred embodiment, the approaches should be acquiring SWI images directly from a routine MRI contrast sequence 410, which can be acquired at the first stage in a medical imaging diagnostic protocol.

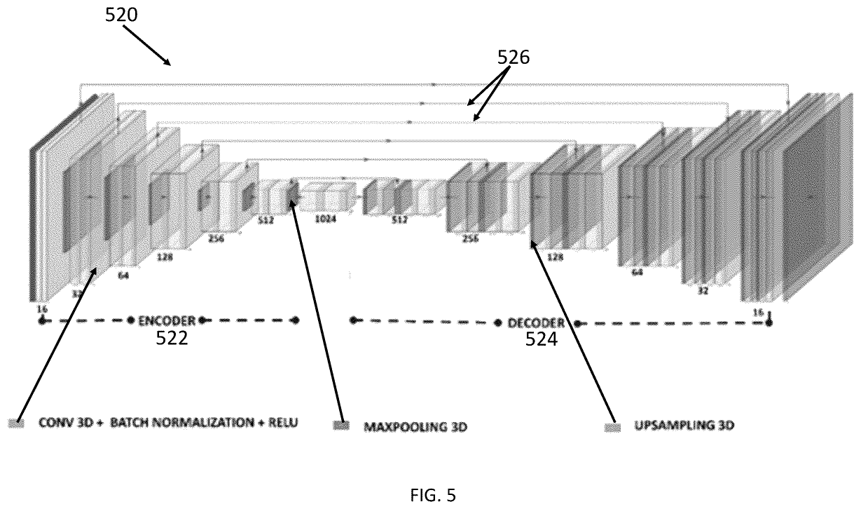

One preferred embodiment of the present invention, the system 100 uses the U-Net framework 500 to synthesize SWI images from T1w MRI contrast. To synthesise an SWI image from T1w MRI, the present invention utilizes an encoder-decoder architecture as shown in FIG. 5, specifically the U-Net framework, to capture both local and global information and provide a comprehensive representation of the input data. U-Net is a well-established approach used for efficient semantic image segmentation. To our knowledge, it is employed here for the first time for generating SWI images from T1w images.

The main contributions of the present invention can be summarized as follows:
1. Introducing a U-Net framework for generating SWI images from T1w images, which has not been investigated before.
2. Providing a solution that optimizes the diagnostic process and minimizes time wastage to address the need for efficient susceptibility-weighted tissue differentiation.
3. Confirming model generality on retrospective clinical datasets, including a stroke dataset, which are not involved in model training.

These contributions can potentially enhance the efficiency and effectiveness of diagnosing neurodegenerative issues by providing a direct and timely pathway to the change of tissues susceptibility quantification.

### Methods

### Datasets

The method of the present invention is evaluated using four separate neuroimaging datasets: the Open Access Series of Imaging Studies-3 (OASIS-3), Study Forrest, the Single Individual Volunteer for Multiple Observations across Networks (SIMON), the ADNI datasets and a private clinical retrospective dataset.

The OASIS-3 dataset is publicly available online via the web with all data obtained from ongoing projects at the Washington University Knight Alzheimer Disease Research Centre for 15 years (https://sites.wust1.edu/oasisbrains/home/oasis-3/). OASIS contains different MRI image modalities, including T1w, T2w, SWI and others from healthy subjects and various stages of cognitive decline patients. For this study, 864 T1w and SWI image modalities were obtained from 1.5 and 3 Tesla scanners. Furthermore, the MRI data are acquired in axial view of 256 slices of images scanned from top to the bottom of the brain. The data were randomly divided into 80% and 20% for training and validation sets.

The Study Forrest dataset is freely available (http://www.studyforrest.org), liberally licensed (PDDL), hosted on multiple platforms (OpenNeuro, GIN). It consists of data collected from 21 participants while they were watching the movie, Forrest Gump. It is used to study brain function and cognition in a naturalistic, complex environment rather than using simplified stimuli. It contains a comprehensive set of auxiliary data (T1w, T2w, DTI, SWI and MRA). The T1w images are with 274 sagittal slices (FOV=191.8×256×256 mm³) and an acquisition of a voxel size is of 0.7′0.7′ 0.7 mm³. A 3D multi-slab time-of-flight angiography was recorded at 7 Tesla.

The Alzheimer's Disease Neuroimaging Initiative (ADNI) database (adni.loni.us.edu) with the primary goal of testing whether serial magnetic resonance imaging (MRI), PET, other biological markers, and clinical and neuropsychological assessment can be combined to measure the progression of MCI and early AD was used for our study.

The AI model of the present invention is validated with the SIMON and retrospective clinical datasets which are not included in the model training and testing process.

The SIMON dataset on the CDIP website (www.cdip-pcid.ca) is valuable for studying model sensitivity to change in MRI image vendors. It is a multi-centre study involving a single volunteer who underwent repeated imaging sessions using scanners from the three major medical imaging vendors-Siemens, Philips, and GE. The core protocol includes an isotropic T1w scan with voxel size 1.0×1.0×1.0 mm³.

The retrospective clinical data obtained acquired from a Philips Achieva 3.0 Tesla MRI Scanner with an 8-channel SENSE head coil for reception. Whole brain sagittal T1w images were acquired with the 3D T1-TFE sequence with the following parameters: TE/TR=3.2/7.0 ms, flip angle=8°, FOV=250×250×155 mm³, matrix size=256×256×155 mm³, nominal and reconstructed resolution=0.97×0.97×1 mm³ and the number of excitations (NEX) is 1. Axial susceptibility-weighted images (SWI) images were acquired with a velocity-compensated 3D fast-field echo sequence with the following parameters: TE/TR=23/28 ms, flip angle=15°, FOV=230×230×180 mm³, acquisition matrix size=256×256×180 mm³, nominal resolution=0.9×0.9×1 mm³, reconstructed resolution=0.45×0.45×1 mm³, NEX=1. The dataset contains 8 Parkinson's disease dementia (PDD) patients (73±6 years), 22 PD patients (63±8 years) and 18 healthy controls (62±7 years).

### Preprocessing

The 3D T1w and SWI images were resampled and registered to a single template in the axial plane using 3D-SyN registration, using ANTSPyx software library. The T1w, and SWI images were further normalized to obtain voxel intensity between 0 and 1 and resized to the same matrix size of (W×H×D)=256×256×64 using the spline interpolated zoom (SIZ) method.

### Model Architecture

In one embodiment of the present invention uses the CNN structure known as U-Net architecture 510 comprises an encoder 522 and a decoder 524 with skip connections 526. Typically, the U-Net is generally used as the generator for GAN models. It is utilized for voxel-wise prediction. The encoder path down samples the input images to extract larger sets of low to high-level features, while the decoder path combines the output from the encoder and extracted image features in multiscale resolution levels to generate the SWI-based target images output through an up-sampling process. Skip connections are added between the reflecting layers in the encoder-decoder network to speed up information transmission between input and output 3D image flows. This helps to learn matching features for the corresponding mirrored layers.

### Model Training

In one embodiment of the present invention, 3D convolutions are implemented in the 3D encoder transformer decoder (ETD)-Net model in one embodiment of the present invention. The 864, T1w and SWI images pairs divided into training and testing at the ratio of 80:20 are utilised to train our ETD-Net model from scratch for each image translation. The model trainable parameters were initialized using a uniform distribution technique since it has been reported. To perform better than the Xavier technique in deep models with ReLU layers, the Adam stochastic optimization algorithm with a learning rate of 0.002 is applied to minimize a mean-squared error (MSE) loss function in a stepwise fashion and update the networks trainable at every training step progressively until the model reaches the convergence. In one embodiment, the MSE is selected as a cost function because it is computationally inexpensive and leads to a convex optimization problem with a stable gradient. Our end-to-end 3D ETD-Net architecture for the T1w to SWI translation. These parameters were optimized during the model training on the training data set to learn a mapping between a source T1w image and a target SWI contrast.

The present invention utilizes the ETD-Net structure 510 to perform cross-sequence from T1w to SWI image translation consisting of 19 convolutional layers as shown in FIG. 5. The input images are 256×256×64 voxels and one channel (grayscale image). The encoder consists of a repeated implementation of two 3×3 convolutions with 2 voxels stride over five-layer blocks, except for the last block and one convolutional layer. Zero padding was used before convolution to maintain the resolution of extracted deeper feature maps matching the resolution of the input feature maps. The first convolutional layer is followed by a rectified linear unit (ReLU) activation layer and a 2×2×2 max-pooling operation with a stride of 2 voxels. Using a ReLU nonlinear transfer function between the hidden convolutional layers has the advantage of computational simplicity and representational sparsity, providing capabilities for better solutions and thereby preventing vanishing gradient problems. In the network, the max-pooling operation after the activation layer reduces the spatial size of the image feature map by a factor of 2, decreasing the computational cost and saving memory while retaining the most salient features. The number of convolutional filters doubles, from 16 in the first block to 1024 in the last. This permits the network to learn the hierarchical relationships over a sizeable receptive field of the MR image.

The decoder part is typically a reflected version of the encoder network. The main exception is that the max-pooling operations in the encoder part are replaced with up-sampling operations in the decoding region, where the nearest-neighbour interpolation increases image size by a factor of 2 through each layer. Because deconvolution uses random initialization and unequalled kernel size, which causes checkerboard artefacts, up-sampling is used for its replacement. Furthermore, the encoder was connected to the decoder through skip connections at multiscale resolution levels to help reconstruct the original spatial resolution levels and to recover the original spatial resolution of the input 3D-T1w image at the output. The features from each block in the encoder are copied and concatenated with their corresponding ones in the decoder. These concatenations enable both high- and low-level features from the encoding part to be utilized as additional inputs in the decoding part to provide effective and stable image representation.

The output layer of our U-Net comprises a 1×1 convolutional layer and a stride of 1 followed by a hyperbolic tangent (tanh) activation function, which has been established to provide good results in many studies. The final layer reconstructs an output image from a 16-component vector of feature maps that has the same size as the input image (256×256×64).

Also, the batch size, defined as the number of samples per gradient update, is set to 1, during which the model is trained for 1000 epochs. The same model is trained to perform the possible translation in the traditional method, which involves translating T1-w images to SWI images. The training of all models is executed on a 64-bit Linux system with an Intel Core and 164 GB RAM using Kera's API with TensorFlow (version 2.8) as the backend in Python (version 3.9; Python Software Foundation).

### Model Evaluation

Visual inspection can be performed on the synthesized SWI images using the difference maps computed as: (Îᵢ, Iᵢ)=Iᵢ−Îᵢ. The quality of the synthesized SWI images (Î) can be evaluated against the ground truth (I) in 3D images of length (L), width (W) and height (H), where 0≤x≤L−1, 0≤y≤W−1, and 0≤z≤H−1 are their spatial coordinates. The two voxel-wise metrics used for the quantitative analysis include peak signal-to-noise ratio (PSNR) and structural similarity index (SSIM) and the SSIM captures the human-perceived quality of the image by comparing two images given

$$\frac{( 2 {μ}_{x} {μ}_{y} + {C}_{1} ) ( 2 {σ}_{xy} + {C}_{2} )}{( {μ}_{x}^{2} + {μ}_{y}^{2} + {C}_{1} ) ( {σ}_{x}^{2} + {σ}_{y}^{2} + {C}_{2} )} ,$$

where μ is the mean image intensity, σ² is the variance of the image, σ_{xy} is the covariance of the ground-truth (x) and predicted (y) images and C₁ and C₂ are constants added to stabilize the division with a weak denominator. Ine one embodiment of the present invention, an average±SEM of the PSNR and SSIM is obtained across all the validation datasets.

### Unique Example Features of the Invention

### Example 1

A system for generating a simulated SWI of a patient's brain based upon a single non-contrast (SNC) MR image of the brain the system comprising:
An input image module to store SNC images of the patient's brain.
A pre-processing module adapted to receive the SNC image, prepare and generate it into the standard required for the model to extract and understand its features effectively.
A simulated SWI-generating model compartment was adapted to receive the patient's SNC images and to generate fake SWI corresponding to each SNC image.
A deep learning platform arranged and structured to operate the connected model.
A training module that receives and communicates the training data to the deep learning platform whereby tunable parameters of the model may be adjusted to optimize the simulated SWI images.
A testing module that communicates with the training module and the deep learning platform to receive testing data whereby pre-trained performance criteria validate the simulated SWI images generated by the model.
An output storage compartment adapted to receive the simulated SWI images generated by the model.

### Example 2

A method for generating simulated SWI of a patient's brain based upon SNC magnetic resonance images of the brain without injection of a contrast agent into the body, the method consisting of:
Collecting singularly SNC images
Inputting the collected SNC images into the training compartment
Collecting a corresponding SWI for each subject in the SNC images
Storing the SWI images in the training compartment
Input the SNC images and the corresponding SWI images into the model.
Training the model to generate a simulated SWI image based upon the SNC images input into the model and the corresponding SWI images as the target output.
Testing the simulated SWI images against the corresponding SWI images previously input into the model and optimizing the model input.

The method of example 2 in which the SNC MR image is a T1-weighted image.

### Example 3

The method of example 2 in which the SNC MR image can be acquired from MRI scanner of any model including GE, Siemens, and Philips.

### Example 4

The method of example 2 in which the SNC MR image can be acquired from MRI scanner of any field strength including 1.5 T, 3T, and 7T.

### Example 5

The method of example 3 in which the training step for the model to generate a simulated SWI image includes applying deep learning techniques.

### Example 6

The method of example 4, in which testing the simulated SWI images against the corresponding SWI images input into the model and optimizing the model output, includes applying deep learning techniques 6. The method of example 5 further includes the following steps:
Acquiring a SNC MR image of a particular patient for a specific study on an MRI scanner,
Registering the SNC MR images for a particular study to a standard non-contrast image template.
Transferring registered SNC MR images for the study to a storage compartment.
Inputting the SNC MR images into the trained model
Generating simulated SWI images corresponding to the SNC MR input images and viewing all images using the available software.

The present invention relates to the Susceptibility Weighted Imaging (SWI) for magnetic resonance imaging (MRI). The present invention is a system adapted to generate a simulated 3D SWI image from a T1-weighted image input without contrast agents and can be used in hospitals, radiological centers, and research institutes as illustrated below.
Disease diagnosis: The non-invasive imaging and detection of haemorrhages in the brain
Iron detection: Detection of iron deposits crucial for diagnosing neurodegenerative diseases like Alzheimer's and Parkinson's disease.
Rapid treatment monitoring: The monitoring of changes in brain vasculatures after treatment of cerebrovascular disease in patients.
Post-surgical Evaluation: The evaluation of bleeding or infection in the brain of post-neurosurgical patients to identify complications.
Scientific discovery: scientist and research groups can use this technology to discover new
treatment paradigms and a better understanding of underlying cerebrovascular mechanisms.

The advantages of example embodiments of the present invention may include, without limitation:
i. The advantages of the present invention over existing technologies are:
ii. It involves no contrast agent compared to the contrast-enhanced SWI sequence.
iii. It offers a fast generation (within a few seconds) of SWI images and no concern over patient motion effect6 on generated images compared to a conventional MRI acquisition.
iv. It erases concern over undesirable magnetic susceptibility sources causing artifacts occurring at air-tissue interfaces.
v. It streamlines MRI imaging protocol.
vi. It provides a cheap means of cerebrovascular disease diagnosis.
vii. It is readily available and can be incorporated into any portable device for easy access.
viii. It provides a more accessible option for the investigation of neurodegenerative disease and complications in post-neurosurgery.
   A Healthy Subject from the SIMON Dataset

A single subject obtained from the validation set of the SIMON dataset was used for the visual and qualitative assessment of the traditional image translation method and the method of the present invention. Firstly, the SWI image (combining magnitude and phase images) obtained at different positions from the 3D T1w image input, together with the input are visualized.

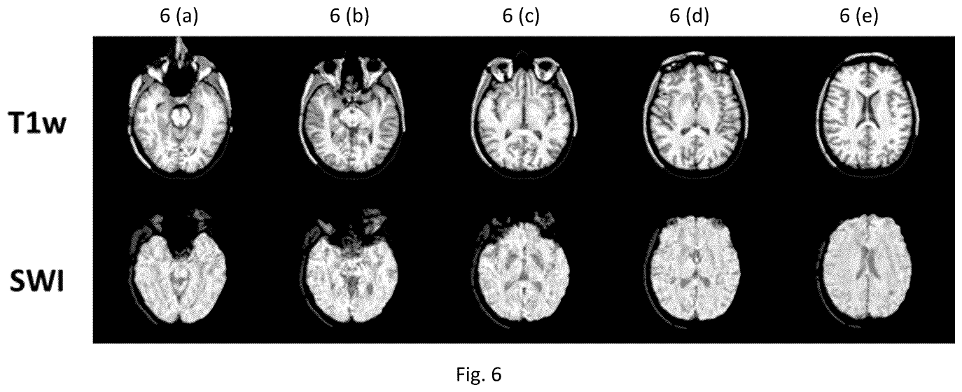

Five axial slices of the SWI image are shown in FIG. 6. FIG. 6 is a demonstration of five axial slices of a T1w image (top row) and an SWI image (bottom row) acquired from an MRI scanner at different depths. The second slice of the SWI image (FIG. 6(b)) demonstrates the substantia nigra in the midbrain, where the dorsolateral nigral hyperintensity (swallow tail sign) in the substantia nigra plays a crucial role in indicating if the subject is experiencing Parkinson's related diseases (Schwarz et al., 2014)). The atrium of the lateral ventricle is shown in FIG. 6(c) and FIG. 6(d) while the sulci of the cerebrum can be studied in FIG. 6(d) and FIG. 6(e).

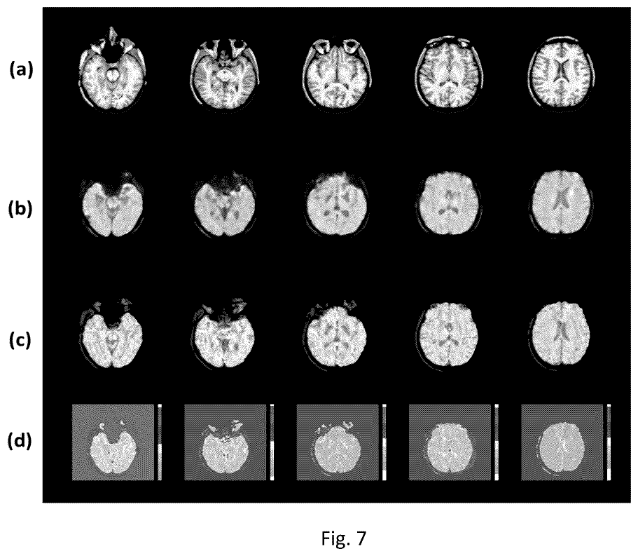

To analyse the prediction result of the SWI scan of a healthy subject, it is presented in FIG. 7 the qualitative evaluation results. FIG. 7: shows the qualitative evaluation of the UNET method with SIMON dataset with a visual inspection of the axial slices at different depths in the (a) T1w input, (b) the synthetic SWI image, (c) the ground truth SWI and (d) the error map (synthetic-ground-truth).

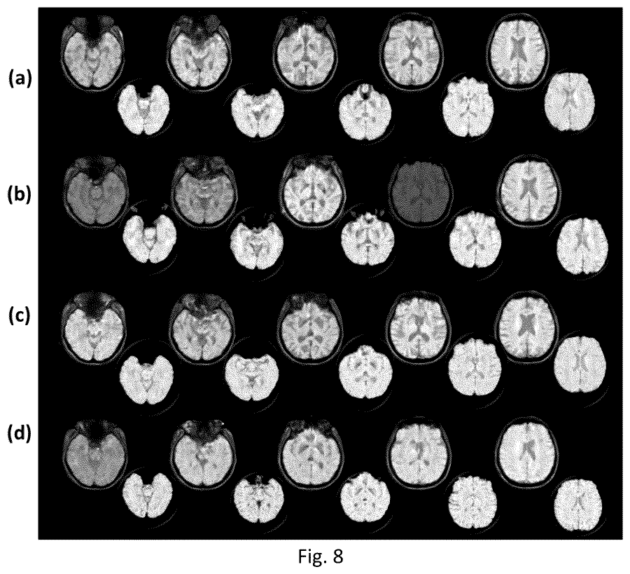

FIG. 7(a) is the T1-w acquired input for the prediction, FIG. 7(b) is the predicted SWI image while FIG. 7(c) is the ground truth of the synthetic SWI scan. In one embodiment of the present invention, the system 200 uses slices that illustrate the major components of the central nervous system (CNS), which are susceptible to differential diagnosis through SWI. It can be observed from FIGS. 8(b) and 8(c) that the predicted results demonstrate anatomical features from the SWI with hyperintensity compared to the ground truth. The features surrounding the grey matter appear bolder and more pronounced. To investigate the Parkinson's disease risk of the subject, it is shown that the shape of the substantia nigra structure and the hippocampus remains the same, i.e., the swallow tail signs are consistent between the predicted image and the ground truth, suggesting that the model accurately predicting this neurological disease condition.

However, the difference map (FIG. 7(d)) highlights the significant variations between the synthesized SWI generated in the present invention and the ground truth, primarily concerning image sharpness. This difference results in a faint, shadowy and hyperintense appearance of major features in the difference map. Nonetheless, this does not affect the utility of the present invention predictions for diagnostic differentiation.

Four Subjects from the Validation Set

Furthermore, the obtained retrospective data and SIMON dataset were utilised for the validation of the model prediction. The SWI image synthesized from the T1 w image for a single subject representing a healthy subject, PD patient and PDD patients are shown in FIGS. 8(a), (b) and (c) respectively while that of the healthy normal subject from the SIMON dataset is as shown in FIG. 8(d). FIG. 8 shows a qualitative evaluation of the UNET method with a visual inspection of the 2D axial slices of SWI at different depths in (a) a healthy subject, (b) and Parkinson's disease dementia patient, (c) a Parkinson's disease patient from a private clinical dataset and (d) healthy subject from the SIMON dataset, where the top row at each group is our prediction and the bottom right is the corresponding ground truth of each scan.

The predicted results of the present invention show a high similarity to the ground truth (bottom right). Five slices are obtained from the synthesized SWI compared with the ground truth SWI displayed as they are qualitatively consistent with the test data of one embodiment of the present invention in terms of SWI image features. Additionally, the small hypointense dots, which may indicate iron deposition or subtle variations in brain anatomy, particularly in the substantia nigra, are more pronounced and consistent in their positions compared to the ground truth. Hence the trained model of the present invention is capable of generalization into a private and public dataset.

Nonetheless, susceptibility-weighted imaging (SWI) excels at differentiating between healthy individuals and those with Parkinson's disease (PD) by highlighting the largest cluster of dopaminergic neurons in the dorsolateral substantia nigra (SN), specifically Nigrosome-1. This region appears as a hyperintense structure against the otherwise hypointense SN, forming the characteristic ‘swallow tail sign’ (STS), which serves as a valuable biomarker.

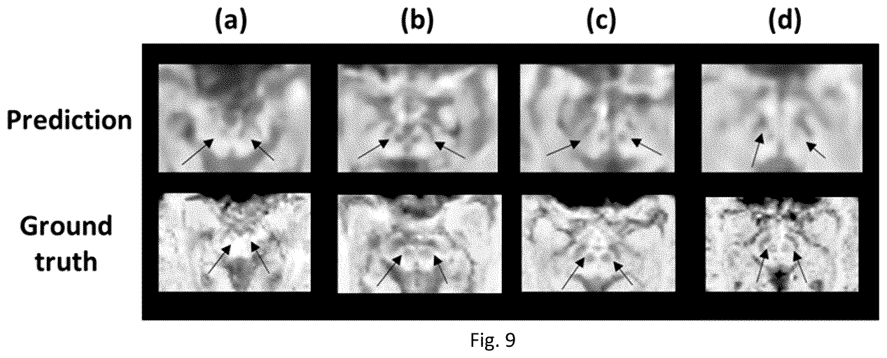

Hence, the present invention utilizes this biomarker to test the capability of the synthesized image to assess the diagnostic capability of the results. The differences between diseased and normal subjects are further analyzed, focusing on the substantia nigra, which is presented in FIG. 9. FIG. 9 shows a qualitative evaluation of the UNET method with a visual inspection of the substantia nigra in a (a) healthy subject, (b) and Parkinson's disease dementia patient, (c) Parkinson's disease patient from a private clinical dataset and (d) healthy subject from the SIMON dataset, corresponding to the subjects in FIG. 8.

It is shown in FIGS. 9(a) and (d) that the swallow tail sign appears in the substantia nigra of healthy subjects, as indicated by the red arrows. For PDD and PD patients, as shown in FIGS. 9(b) and (d), there is a loss of the dorsolateral nigral hyperintensity. However, the reliability of using swallow-tail signs to differentiate PD patients from healthy subjects remains a concern as some studies have reported that there may be inconsistency of the swallow-tail sign within the healthy population.

### Application to Stroke Dataset

SWI is known for its ability to detect microbleeds, which increase the risk of haemorrhage. In this study, SWI images are synthesized from T1-weighted images of ischemic stroke patients obtained from the ATLAS dataset.

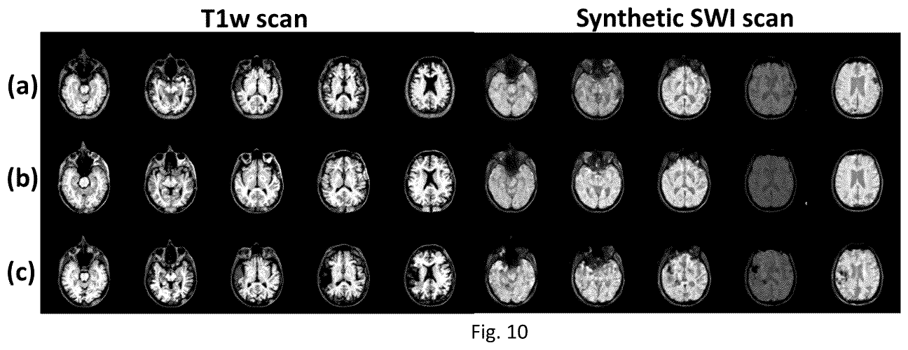

FIG. 19 shows a qualitative evaluation of the model with a visual inspection of the T1w scan (left panel) and the synthetic SWI scan (right panel) for three ischemic stroke subjects. For the T1w images, Subject 1 (FIG. 10(a)) is a subject with lesions at both the left and right subcortical regions, subject 2 (FIG. 10(b)) has large lesion on the right subcortical region covering the temporal lobe, insula, and parietal lobe and subject 3 (FIG. 10(c)) has lesion on the left subcortical region.

In the synthesized SWI images, some lesions in the (right subcortical region of subject 1 and left subcortical region of subject 2) appear as hypointense areas. In contrast, some areas of the lesion (in the left subcortical region of subject 1 and right subcortical region of subject 3) appear more hypointense. The pronounced hypointensity may indicate the accumulation of microbleeds. This observation underscores SWI's capability to reveal multiple microbleeds, which could suggest a diffuse haemorrhage-prone vasculopathy.

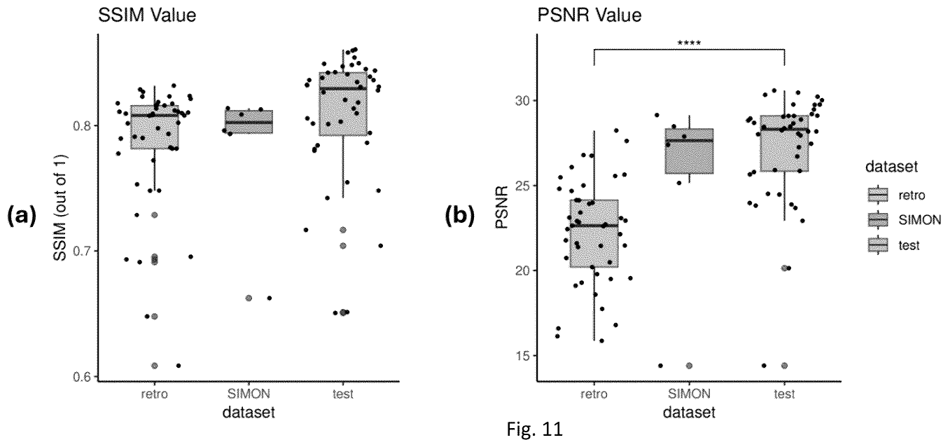

The synthesized SWI images for the test set (OASIS-3 and Study Forrest), the retrospective private clinical validation dataset and the SIMON dataset are quantitatively evaluated. The evaluation metrics used are SSIM and PSNR. These metrics are employed to assess the quality of the synthesized SWI images in 3D compared to their corresponding ground truth images. The results are shown in the FIGS. 11 to 13 boxplots.

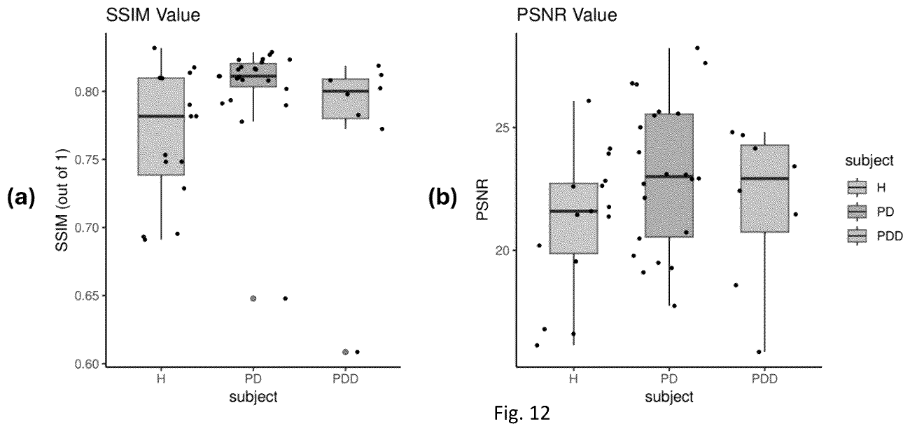

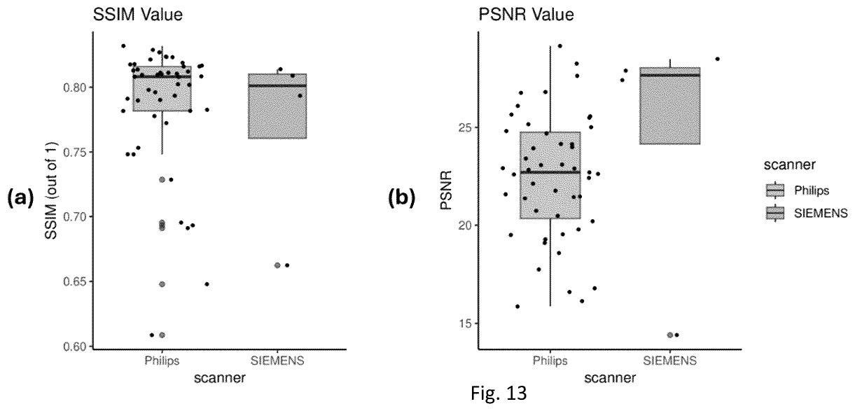

FIG. 11 shows boxplots for the (a) structural similarity index measure (SSIM) and (b) peak signal-to-noise ratio (PSNR) for the retrospective private clinical dataset (pink), SIMON dataset (green) and the test set (blue). FIG. 12 shows boxplots for the (a) structural similarity index measure (SSIM) and (b) peak signal-to-noise ratio (PSNR) for the healthy (H), Parkinson's disease (PD) and Parkinson's disease dementia (PDD) subjects within the retrospective dataset. FIG. 13 shows boxplots for the (a) structural similarity index measure (SSIM) and (b) peak signal-to-noise ratio (PSNR) for results generated from a T1w scan from a Philips (pink) or SIEMENS (blue) scanner.

### Model Accuracy on Test Set and Validation Dataset

As observed from FIG. 11, there is a significant statistical difference, where a Welch Two Sample t-test is used across each pair of datasets to give a p-value of 7.08e-11, in the PSNR between the test subjects and validation subjects from the retrospective dataset. Comparing the subset of the retrospective dataset and SIMON dataset shows no significant difference. This may be because the metrics are obtained by comparing the prediction of an SWI image (combination of magnitude and phase image) of the retrospective dataset and a magnitude image of the ground truth dataset. Also, the skull stripping preprocessing of the ground truth SWI not present in the synthesized SWI.

The prediction quality within the private clinical validation dataset based on the disease status of the subjects are further investigated. As shown in FIG. 12, it is observed that the prediction from PD has the highest metric values among all the subjects from the retrospective dataset, which could be due to the higher number of diseased than normal subjects present in the training dataset. However, no statistically significant difference is observed. The average SSIM was maintained within a range of 0.78±0.02 respectively for the retrospective data, as suggested by Table 1.

TABLE 1
Summary of the sample size, SSIM and PSNR
computed on subjects from various datasets.

| | (a) retro | (b) SIMON | (c) test | (d) retro - H | (e) retro - PD |
|---|---|---|---|---|---|
| Sample | 45 | 6 | 44 | 15 | 22 |
| Size | | | | | |
| SSIM | 0.786 ± | 0.781 ± | 0.809 ± | 0.766 ± | 0.803 ± |
| | 0.0074 | 0.0240 | 0.0077 | 0.0124 | 0.0079 |
| PSNR | 22.3 ± 0.459 | 25.4 ± 2.27 | 27.3 ± 0.468 | 21.2 ± 0.747 | 23.1 ± 0.648 |

| | (f) retro - | | |
|---|---|---|---|
| | PDD | (g) Philips | (h) SIEMENS |
| Sample | 8 | 47 | 4 |
| Size | | | |
| SSIM | 0.775 ± | 0.787 ± | 0.770 ± |
| | 0.0244 | 0.0071 | 0.0360 |
| PSNR | 21.9 ± 1.13 | 22.5 ± 0.467 | 24.5 ± 3.39 |

### Model Performance on PD Prediction

To evaluate the relationship between the prediction quality of the proposed model across multiple centres and scanners, scans from the private retrospective dataset and the SIMON dataset are being investigated. It is shown in FIG. 13 that the SSIM is similar between the two groups where they are within a range of 0.77±0.01. For PSNR, it is observed that SIEMENS poses a higher value suggesting a better quality of the prediction although no significant difference is observed. It can be explained by the fact that most data from the Philips group are obtained from the retrospective data, which leads to the same discussion as in FIG. 11. Remarkably, the trained model of the present invention shows no discrimination between the different scanners. This indicates that our model can generalize well to predict SWI images from any 3D T1w input from any scanner.

### Model Performance on PD Prediction

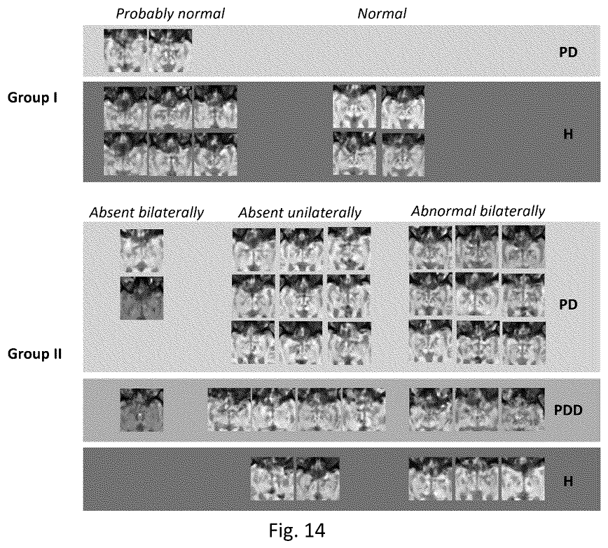

The performance of the model on Parkinson's disease (PD) prediction is evaluated utilising the retrospective private clinical dataset. Scans are classified into two groups. Group I: “normal” (swallow-tail sign (STS) looks normal or probably normal) and Group II: “abnormal” (STS absent bilaterally or unilaterally, STS looks abnormal bilaterally). Diagnostic accuracy was assessed against clinical diagnosis as gold standard. The classification of the predicted SEI images is shown in FIG. 14. FIG. 14 shows the classification of the predicted SWI scan from the T1w acquired from the retrospective private clinical dataset.

The results are summarised into the following table.

| | Group II | Group I | |
|---|---|---|---|
| | “abnormal” | “normal” | |
| Diseased | 28 | 2 | 30 |
| (PD/PDD) | | | |
| Healthy | 5 | 33 | 48 |
| | 10 | 33 | 43 |

The Fisher's exact test, a non-parametric test, is used to assess the association between the predicted disease group classification and the ground-truth disease status, since the sample size is relatively small. Note that R Studio, Version 4.4.1 (Hong Kong) was used for the statistical analysis. Assuming a significance level of 0.05, we obtain a p-value of 0.0003, which is smaller than the threshold, indicating that there is evidence to reject the null hypothesis.

In addition, SWI can support the differential diagnosis of other central nervous system (CNS) disorders.

Cerebral hyperperfusion syndrome (CHS) is a complication of carotid endarterectomy (CEA) or carotid artery stenting. After the development of CEA, the SWI showed a prominent hyperintensity of cortical arteries in the right MCA territory. This hyperintensity gradually diminished over time until it became indistinct. Concurrently, SWI revealed increased signal intensity in cortical veins and periventricular veins at the peak of regional cerebral blood flow (rCBF), followed by a progressive decrease in signal intensity as rCBF declined, ultimately returning to normal levels. The changes in the SWI signal intensity of mentioned vessels in an ipsilateral MCA territory after CEA may provide valuable information regarding hyperperfusion, where abnormally increased CBF and decreased oxygen extraction fraction may not allow for sufficient elevation of deoxyhemoglobin levels causing adequate susceptibility effects. Susceptibility effect visible on SWI in the follow-up MR after CEA might be useful in the assessment of the recovery of cerebral circulation and the risk of CHS.

Multiple sclerosis (MS) plaques are formed along the course of cerebral vessels and their ovoid shape is determined by the location and orientation of veins. SWI demonstrates the central vein sign (CVS) as fine linear hypointensity within the lesion. The CVS is more common in MS than in other diseases and therefore it becomes a valuable marker, which can be useful for confirming MS diagnosis. In addition, SWI image show small, diffuse hypointenstity corresponding to the hyperintense focus in the white matter of the right frontal lobe, can be interpreted as iron deposits in the MS plaque.

As in the case of traumatic brain injury, after one to three days, the acute haematoma essentially consists of deoxyhaemoglobin that results in markedly hypointense signal both on T2 weighted images and SWI. In the low field scanners the acute haematoma may be isointense to brain parenchyma and SWI would improve the detection of haematoma in that condition. In the late subacute stage, approximately after 7 days, the signal changes due to impaired cellular integrity and the presence of methaemoglobin in extracellular compartment. On SWI haematoma presents with hyperintense signal due to the lack of significant susceptibility effects of extracellular methaemoglobin.

The diagnosis of diffuse axonal injury (DAI) can be established using MRI, where it is characterized by multiple small regions of susceptibility artifacts visible on susceptibility-weighted imaging (SWI). SWI is particularly sensitive in detecting hemorrhagic shearing lesions compared to other imaging modalities. Additionally, SWI provides detailed information on the distribution of injuries and contributes valuable insights for predicting clinical outcomes. Notably, the presence of microbleeds on SWI is associated with poorer cognitive outcomes. In the acute phase of subarachnoid hemorrhage (SAH), the absence of low signal on susceptibility-weighted imaging (SWI) within the subarachnoid space—due to the limited breakdown of red blood cells—does not exclude the presence of SAH. However, SWI can be particularly valuable in detecting SAH along the interhemispheric fissures. SWI is also adapted to detecting and differentiating chronic microbleeds from calcifications. Hemoglobin, its degradation products, and calcifications appear as hypointensities on SWI due to signal attenuation caused by T2* shortening. Differentiation between microhemorrhages and calcifications can be achieved using phase imaging, based on their distinct magnetic properties. Paramagnetic materials, such as hemosiderin, enhance the external magnetic field, resulting in a negative phase shift in the right-hand coordinate system (RHS). In contrast, calcium, being diamagnetic, weakens the external magnetic field, leading to a positive phase shift in RHS.

Cerebral microbleeds (CMBs) can be detected with SWI, where CMBs appear as small, round or ovoid signal voids with blooming artifact. The CMBs visible on SWI may be an auxiliary tool in the differential diagnosis. Common locations of CMBs in Cerebral autosomal dominant arteriopathy with subcortical infarcts and leukoencephalopathy (CADASIL) are thalamus, basal ganglia, subcortical white matter, brainstem, cerebellum, and the grey-white matter junction.

Developmental venous anomalies (DVAs) are congenital variations in venous drainage. Susceptibility-weighted imaging (SWI) enables the visualization of DVAs without requiring contrast medium administration. SWI plays a crucial role in diagnosis, as it can reveal signal hypointensities indicative of slow venous flow, which may not be visible on other MRI sequences.

DVAs may occur in association with cerebral cavernous malformations (CCMs). Small CCMs, which can be missed on conventional spin-echo sequences, are often well-detected using SWI. Multiple CCMs are present in up to one-third of sporadic cases and, though less common, can also occur in patients with the rare genetic disorder known as Familial Multiple Cavernous Malformation Syndrome (FCCMS). In FCCMS, the number of cavernomas is typically five or more, with additional lesions potentially developing over time.

Follow-up MRI with SWI is particularly valuable in managing the familial form of the disease, aiding in treatment planning and reducing the risk of cerebral hemorrhage and related complications. Due to its sensitivity to blooming artifacts, SWI is the most effective imaging modality for detecting multiple hemangiomas, including very small lesions, without the need for contrast agent administration.

SWI offers unique advantages in the detection of arterio-venous shunting (AVS), given the intrinsic contrast between rapidly flowing, oxygenated and hyperintense arterial blood and slowly flowing, deoxygenated, hypointense venous blood. This phenomenon is observed regardless of vessel caliber. Additionally, it has been investigated that in case of high-flow brain vascular malformations (BVM) hyperintensity seen on SWI within the venous structures draining BVM is an accurate indicator of AVS and venous hypertension, and is directly associated with an increased risk of ICH in the surrounding area.

MRI with SWI is also used to identify potential underlying IIA. This is especially important in cases that may require intervention to prevent life-threatening complications. Thrombosed aneurysm has a unique characteristic on SWI. The periphery of thrombosed aneurysm is SWI-hypointense, likely due to the superparamagnetic effects of accumulating hemosiderin and ferritin, when the centre is SWI-hyperintense, due to the long T2-relaxation of dissolving haemoglobin

Most of the primary central nervous system vasculitis (PCNSV) cases demonstrate intralesional microhaemorrhages seen as small linear or punctate patterns on either GRE-T2* or SWI and these are typical MR findings highly suggestive of CNS vasculitis. Localized leptomeningeal and subependymal enhancement adjacent to the lesions may also be seen. SWI showed numerous, punctate/linear low-signal foci in the basal ganglia (more on the right sight), corresponding to a small blood vessels, not visible on other MR sequences-typical SWI findings suggestive of vasculitis.

SWI can be used to identify foci of hemorrhage or calcification and reveal pathological microvascularity within tumors. Differentiation between blood breakdown products and calcium deposits can be achieved using phase images. SWI is particularly useful for distinguishing between cerebellopontine angle schwannomas and meningiomas, as microhemorrhages may occur in schwannomas but are not typical of meningiomas. Additionally, calcifications are present in approximately 70-90% of oligodendrogliomas and can be readily detected using SWI. SWI differentiates glioblastoma from primary CNS lymphoma (PCNSL) with high sensitivity and specificity.

The assessment is based on what are known as intratumoral susceptibility signals (ITSS). ITSS are characterized by fine linear or dot-shaped structures that display low signal intensity on SWI. These signals may arise from small blood deposits or microcalcifications. It has also been suggested that ITSS could represent pathological blood vessels within the tumour. The presence of ITSS on SWI is indicative of neo-angiogenesis and an increased cerebral blood volume (CBV), both of which are commonly observed in glioblastoma.

Lipomas typically demonstrate very thin peripheral hypointense rim on SWI, commonly known as India ink artifact. Lipoma and haematoma show similar MRI characteristic-both appear hyperintense on T1 and show blooming on SWI but yet their differentiation is possible with FLAIR, where lipoma appear hypointense, whereas haematoma maintains its hyperintense signal. The classical imaging appearance of ruptured intracranial dermoid is a fat-containing lesion with tiny fat droplets in the subarachnoid space or ventricular system. The lesion and the fat droplets show blooming artifact on SWI, similar to lipoma

SWI plays a crucial role in differentiating pyogenic brain abscesses (BA) from other ring-enhancing lesions. The dual-rim sign, visible on SWI, consists of two concentric rims surrounding the pyogenic abscess cavity: the outer rim appears hypointense, while the inner rim is relatively more hyperintense. In pyogenic abscesses, the hypointense outer rim is complete and fully encircles the lesion. In contrast, gliomas and abscesses with etiologies other than bacterial tend to have an incomplete hypointense rim, which only partially borders the lesion.

SWI has become useful method in diagnosing Cerebral venous thrombosis (CVT) since it provides relevant information complementary to other MR sequences. SWI enhances the CVT, particularly in the acute and chronic stages. The thrombosed cortical veins or sinuses can be directly visualized as areas of hypointensity due to the clot. Engorgement of the venous system, along with pronounced hypointensity, may suggest venous stasis and slow collateral flow. Early signs of venous congestion observed on SWI can help identify CVT at an early stage, prior to the onset of infarction or hemorrhage, facilitating timely diagnosis and intervention.

SWI has been proven for supporting the diagnosis of different brain diseases. In one embodiment of the present invention, the system 200 further comprises a diagnostic model adapted to classifying the present or absent of abnormality in the simulated simulated SWI images for characterising brain diseases. In one embodiment, the abnormality is the absent of a swallow tail sign in a substantia nigra of the simulated SWI images for characterising of Parkinson's disease.

The solution of the present invention is to address the need of generating digital twin populations of SWI at a scale for use in in-silico studies and in-silico trials. It is demonstrated that the single-contrast structural MR images (mainly T1w) of the brain can be utilised to synthesize anatomically plausible 3D SWI images using the proposed UNET trans-based image translation framework. Since 3D SWI images offer information about tissues with a different magnetic susceptibility from its surrounding, it is useful for detecting brain pathologies, which is desirable in diagnosing PD patients than T1w, T2w and PD scans. Hence, we have no concern over the challenges in acquiring this scan.

The present invention leverages complementary information from single-contrast structural MR images to learn how to map their corresponding 3D SWI image in a subject-specific manner. A shared latent embedding for single-contrast MR images from the source domains (T1w) is realized through an encoder network and used to synthesize SWI images with a decoder network. The direct approach of translating T1w images to SWI images sets this work apart as it offers a more straightforward and efficient method for obtaining SWI images enhanced patient comfort.

The present invention is able to demonstrate that the system 200 can effectively drive SWI synthesis from the validation set when the target domain is significantly different from the training domain. The present invention also demonstrates the ability to generalize completely unseen data (retrospective dataset) of healthy, Parkinson's disease and Parkinson's dementia disease subjects whilst synthesizing 3D SWI showing swallow tail in the substantia nigra is a useful diagnostic differentiation of specific diseases.

To bolster the capability of the model to predict vessel damage corresponding to lesions present in T1w images, some selected subjects with clear lesions from ATLAS dataset of ischemic stroke subjects are employed. The result of the present invention showcased the model's effectiveness in translating tissue contrast abnormalities in T1w images from the Atlas dataset of ischemic stroke subjects into the SWI domain. This demonstration highlights the importance of our algorithm in predicting two distinct types of abnormalities in SWI: hypointensity of lesion regions and accumulated microbleed regions not shown by T1 weighted of the stroke patients (stenosis). The importance of using the change in magnetic susceptibility effect offered by SWI to stroke patients is therefore emphasized to early detect a transition of the lesion to haemorrhagic incidence. In essence the severity of stroke lesions further obtained through detection of microbleeds strengthens the clinical relevance of our approach.

One limitation of the present invention is that the model only predicted the SWI (combination of magnitude and phase SWI mages), as other useful scans of SWI such as the phase image and venographic image which provide vital information about the calcification effect and vasculature respectively are not provided. Improving the model to produce a better contrast image prediction and to generate other components of SWI image remains a future challenge.

Nevertheless, future improvement of the present invention should aim to assess the generalizability and performance of the proposed network in synthesizing SWI images across a broader range of pathologies. The results can demonstrate the potential of the present invention in generating digital twin cohorts of magnitude image of SWI on a large scale, utilizing the structural T1w images commonly acquired in population imaging. This framework could serve as a platform for curating libraries of whole-brain vascular geometries, enabling the scaling up of in-silico studies and in-silico trials to assess sequences sensitive to the change of magnetic susceptibility.

The successful synthesis of 3D SWI images from T1w MRI has the potential to significantly impact various clinical applications. Additionally, the present invention can provide a more accessible alternative to traditional SWI imaging, which requires specialized equipment and expertise. By generating SWI-like information from widely available T1w MRI, the present invention can contribute to improved patient care and clinical decision-making.

The present invention demonstrates the synthesis of 3D SWI images from a single contrast 3D MR image using an encoder-transformer-decoder (ETD) architecture. The synthesized images retain all essential morphological features needed by SWI for diagnostic application. The present invention offers advantages in terms of simplicity, accuracy, and preservation of magnetic susceptibility features. The results pave the way for the easy creation of digital 3D SWI images without concerns about introducing hallucination in the SWI of normal and diseased subjects.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A system for generating a simulated SWI image of a human brain based upon a single non-contrast (SNC) magnetic resonance (MR) image of the human brain, wherein the system comprising:
an input image module to store the SNC MR images;
a pre-processing module for receiving the SNC MR image, wherein the pre-processing module is adapted to prepare and generate the SNC MR image into a standard format for an artificial intelligence (AI) model to extract and classify features of SNC MR image;
a simulated SWI-generating model compartment for receiving the SNC MR images in the stand format and to generate simulated SWI image corresponding to each SNC image;
a deep learning platform for operating the AI model, wherein the AI model is a connected;
a training module for receiving and communicating training data to the deep learning platform whereby tunable parameters of the AI model may be adjusted to optimize for generating the simulated SWI image;
a testing module for communicating with the training module and the deep learning platform to receive testing data, wherein the testing module is adapted to validate the simulated SWI image with pre-trained performance criteria;
an output storage compartment for receiving and storing the synthetic SWI image.

2. A method for generating simulated SWI images using acquired single contrast MR image (T1-w MR image) by a system having at least a processor and a memory therein to execute instructions of an artificial intelligence engine configured to a UNet model stored within the memory of the system; wherein the UNet model comprises:
an encoder having a plurality of layer blocks, each of the layer blocks of the encoder comprising one or more convolutional layers, each of the convolution layers associating with an activation layer, and a down sampling layer;
a decoder having a plurality of layer blocks, each of the layer blocks of the decoder comprising one up-sampling layer, one or more convolutional layers, and each of the convolution layers associating with an activation layer;
a skip connection for associating with one of the layer blocks of the encoder with one of the layer blocks of the decoder at a corresponding multiscale resolution level;
wherein the encoder is adapted to extract features from the T1-w MR image for the decoder to combine outputs from the encoder and extracted image features in multiscale resolution levels through the skip connection to generate the simulated SWI images.

3. The method of claim 2, wherein the encoder and the decoder are adapted to perform cross-sequence from a T1-w image to SWI image translation consisting of 19 convolutional layers.

4. The method of claim 3, wherein the encoder is adapted to receive images comprising three dimensions and one or more color channels, wherein one or more layer blocks of the encoder comprises a repeated implementation of two 3×3 convolution layers with 2 voxels stride over five-layer blocks, and wherein a layer block of the encoder that immediately precedes the decoder comprises a single convolution layer.

5. The method of claim 4, wherein the activation layer is adapted to conduct a linear rectification function by one or more rectified linear units (ReLU).

6. The method of claim 5, wherein the down sampling comprises a 2×2×2 max-pooling operation with a stride of 2 voxels, wherein each of the convolutional layers is adapted to process input data with a number of convolutional filters.

7. The method of claim 6, wherein the max-pooling operation after an activation layer reduces a spatial size of an image feature map by a factor of 2, and the number of convolutional filters doubles, from 16 in a first block to 1024 in a last block, such that the UNet model is permitted to learn a hierarchical relationships over a sizeable receptive field of the SNC MR image.

8. The method of claim 7, wherein the up-sampling layer of the decoder is adapted to perform nearest-neighbor interpolation to increase image size through each layer block by a factor of 2 through each layer within the decoder.

9. The method of claim 8, wherein one or more convolution layers with the decoder uses random initialization and unequalled kernel size.

10. The method of claim 9, wherein the skip connection is adapted to copied and concatenated features generated from one of the layer blocks of the encoder to one of the layer blocks of the decoder at a corresponding multiscale resolution level, such that both high- and low-level features from the encoder to be utilized as additional inputs in the decoder to provide effective and stable image representation.

11. The method of claim 10, wherein the output layer comprises a single output convolutional layer followed by an output activation layer, wherein the single output convolutional layer is a 1×1 convolutional layer with a stride of 1, and the output activation layer is adapted to conduct hyperbolic tangent (tanh) operations.

12. The method of claim 11, wherein the system further comprises a diagnostic model adapted to classifying an abnormality in the simulated SWI images for characterization of a brain diseases.

13. A method for generating simulated SWI images of a human brain based upon SNC MR images of the human brain without injection of a contrast agent into the body, the method comprising the steps of:
collecting SNC images;
inputting the SNC images into a training module; compartment;
collecting a corresponding SWI image for each subject in the SNC images;
storing the SWI images in the training compartment;
input the SNC images and the corresponding SWI images into an AI model;
training the AI model to generate a simulated SWI image based upon the SNC images input into the AI model and the corresponding SWI images as target outputs;
testing the simulated SWI images against the corresponding SWI images previously input into the AI model and optimizing the AI model input.

14. The method of claim 13, wherein the SNC MR image is a T1-weighted image.

15. The method of claim 14, wherein the SNC MR image is acquired from a MRI scanner of any model, including GE, Siemens, and Philips.

16. The method of claim 15, wherein the SNC MR image can be acquired from MRI scanner of any field strength including 1.5 T, 3T, and 7T.

17. The method of claim 16, wherein the training step for the AI model to generate the simulated SWI images comprises the step of applying deep learning techniques.

18. The method of claim 17, wherein the steps of testing the simulated SWI images against the corresponding SWI images previously input into the AI model and optimizing the AI model input comprises the step of applying the deep learning techniques.

19. The method of claim 18, further comprising the steps of:
acquiring a SNC MR image of a person on an MRI scanner,
registering the SNC MR images to a standard non-contrast image template;
transferring registered SNC MR images to a storage compartment;
inputting the SNC MR images into a trained AI model;
generating simulated SWI images corresponding to the SNC MR input images and viewing images using a pe-existing software.

20. The method of claim 19, wherein the step of training the AI model utilize an Adam stochastic optimization algorithm with a learning rate of 0.002 applied to minimize a mean-squared error (MSE) loss function in a stepwise fashion and update at every training step progressively until the AI model reaches convergence.
